(19) United States
(12) Patent Application Publication
(10) Pub. No.: US 2016/0210660 A1
(43) Pub. Date: Jul. 21, 2016

(54) ENHANCED ADVERTISEMENT SERVER

(71) Applicant: Michael Flynn, Newtown, PA (US)

(72) Inventor: Michael Flynn, Newtown, PA (US)

(21) Appl. No.: 15/083,023

(22) Filed: Mar. 28, 2016

Related U.S. Application Data
(63) Continuation-in-part of application No. 14/701,509, filed on Apr. 30, 2015.
Application No. 14/701,509 is a continuation-in-part of application No. 14/882,875, filed on Oct. 14, 2015.
Application No. 14/882,875 is a continuation-in-part of application No. 14/329,929, filed on Jul. 12, 2014.
(60) Provisional application No. 61/986,175, filed on Apr. 30, 2014.
(60) Provisional application No. 62/017,517, filed on Jun. 26, 2014.
(60) Provisional application No. 61/845,753, filed on Jul. 12, 2013.

(51) Int. Cl. G06Q 30/02

(52) U.S. Cl. CPC G06Q 30/0246; G06Q 30/0241; G06Q 30/0261; G06Q 30/0267; G06Q 30/0276

(57) ABSTRACT

An advertisement server is disclosed including a method of enhancing an advertisement database. The method may include receiving ad content by an advertisement server and storing the ad content in non-volatile memory that is communicatively connected to the advertisement server, receiving, by the advertisement server, ad rules related to the ad content and storing the ad rules in the non-volatile memory with a correlation to the ad content, receiving, by the advertisement server, a selection of a digital effect that is associated with the ad content, and storing the digital effect in the non-volatile memory. The method may include assembling, by the advertisement server, the ad content, the ad rules and the digital effect to create a glow ad, and sending, the glow ad to the advertisement database.

### RELATED APPLICATIONS

This application is related to and claims priority to non-provisional patent application Ser. No. 14/701,509 filed on Apr. 30, 2015, which claims priority to provisional application Ser. No. 61/986,175, filed on Apr. 30, 2014, and provisional application 62/017,517 filed on Jun. 26, 2014; to non-provisional application Ser. No. 14/882,875 filed on Oct. 14, 2015; and to non-provisional application Ser. No. 14/329,929 filed on Jul. 12, 2014, which claims priority to provisional patent application 61/845,753 filed on Jul. 12, 2013, and provisional patent application 61/986,175 filed on Apr. 30, 2014. This application claims international date priority from these applications as a Continuation-In-Part application. The aforementioned patent applications are pending applications, the subject matter and disclosures of which are incorporated herein by reference in their entirety.

### SUMMARY

In embodiments of the described and illustrated enhanced advertisement server system and methods include a method of enhancing an advertisement database. The method may include receiving ad content by an advertisement server and storing the ad content in non-volatile memory that is communicatively connected to the advertisement server, receiving, by the advertisement server, ad rules related to the ad content and storing the ad rules in the non-volatile memory with a correlation to the ad content, receiving, by the advertisement server, a selection of a visual or nonvisual (audio, sensory) digital effect that is associated with the ad content, and storing the digital effect in the non-volatile memory. The method may include assembling, by the advertisement server, the ad content, the ad rules and the digital effect to create a glow ad, and sending, the glow ad to the advertisement database.

The advertisement server may include an ad designing engine that receives the ad content, the ad rules, and offer content. The advertisement server may include an ad designing engine that may include an ad content module, an offer content module, and an ad rules module. The ad rules module may receive an ad attribute. The ad attribute may include target user demographics, target user interests, target user preferences, geographic user scope, ad budget, delivery platforms, type of ad, and terminal impression.

The advertisement server may include an effects designing engine that displays multiple digital effect choices, and receives the selection of the digital effect.

The advertisement server may include an ad packaging engine that attaches a communication tag to the glow ad to allow the glow ad to communicate with a glow server. The glow ad may include an ad delivery tag, a glow rules tag, an interactivity tag, an impression counter, and/or a communication tag.

The method may include receiving, by the advertisement server, a user location, comparing the user location to a public-display location of a fixed public display to determine a proximity value; and sending a first glow ad to the fixed public display based on the proximity value. The method may include receiving multiple user locations, comparing the multiple user locations to the public-display location, and sending the glow ad based on the multiple user locations.

Alternatively, the method may include receiving, by the advertisement server, a user location, comparing the user location to a semi-private or private-display location of a fixed semi-private or private display to determine a proximity value; and sending a first glow ad to the fixed display based on the proximity value. The method may include receiving multiple user locations, comparing the multiple user locations to the semi-private or private display location, and sending the glow ad based on the multiple user locations. Displays may include virtual reality (V/R) or augmented reality (A/R) viewing devices.

The method may include sending a second glow ad that is related to the to the first glow ad to a user-specific display that is within a defined area for viewing the public display at substantially the same time as the first glow ad is sent to the fixed public display. Alternatively, the method may include sending a second glow ad that is related to the first glow ad to a user-specific display that is within a defined area for viewing the semi-private or private display at substantially the same time as the first glow ad is sent to the fixed semi-private or private display.

The method may include receiving interaction data that is related to interaction with the digital effect. The interaction data may include facial expression recognition data, gesture recognition data, eye-tracking data, voice capture data.

In some embodiments an advertisement server may include an ad designing engine that receives ad content and stores the ad content in non-volatile memory, an ad rules module that receives ad rules related to the ad content and stores the ad rules in the non-volatile memory with a correlation to the ad content, an effects designing engine that displays multiple digital effect choices for the ad content, and receives a selection of a digital effect, and an ad packaging engine that attaches a communication tag to the ad content.

The advertisement server may assemble the ad content, the ad rules, the digital effect and the communication tag to create a glow ad.

The following detailed description includes references to the accompanying illustrations which form a part of this detailed description. Example embodiments are described in enough detail to enable those skilled in the art to practice the present subject matter. However, it will be apparent to one of ordinary skill in the art that the present invention may be practiced without some of these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of what is defined and claimed. The following detailed description is, therefore, not to be taken as a limiting sense, and the scope is defined by the appended claims and their equivalents which are to be understood in their broadest possible sense.

In this document, the terms “a” or “an” are used, as is common in patent documents, to include one or more than one. Furthermore, the term “or” is used to refer to a nonexclusive “or,” such that “A or B” includes “A but not B,” “B but not A,” and “A and B,” unless otherwise indicated. Non-volatile and non-transitory computer-readable media comprise all computer-readable media except for a transitory, propagating signal.

### BRIEF DESCRIPTION OF THE DRAWINGS

Embodiments of the described apparatus are illustrated by way of example in the figures of the accompanying drawing sheets, in which like references indicate similar elements and in which:

FIG. 1 is a flow chart of an embodiment of a system for an advertiser to create a glow ad;

FIG. 2 is an illustration of an embodiment of a glow ad and an ad database;

FIG. 3 is an illustration of an embodiment of an ad database connected to ad platforms; and

FIG. 4 is a block diagram of an embodiment of an ad server system.

### DETAILED DESCRIPTION

The disclosed subject matter relates to the field of digital advertisement (ad) server systems. Ads may be stored in an ad server database “on the cloud” and may be targeted and communicated to users on mobile devices, websites or social media. Ads may be stored in an ad server and “called” via an ad targeting system. Ad targeting systems may attempt to determine information about a user, such as a user's interests, using various methods of using a user's “cookies” or other electronic tracking tags in an attempt to direct the most appropriate ads to those users. Ad targeting systems may use various methods and algorithms to call, from an ad server, an ad with certain attributes or tags and then deliver that ad to the user's device. Digital ad campaigns using third-party ad servers may use a “pay-per-click” monetization scheme, where an advertiser pays for each user “impression”, so that an advertiser pays more for ads “clicked” by a user than ads not clicked.

Problems with the past systems are manifold. Past ad systems may have targeting that is “hit and miss” and often ads of little or no interest to a user are called and displayed. More and more users are annoyed by ads and therefore users install ad blocking software to “block” the ads being directed to their browsers or mobile devices from advertising servers. In this way, the past systems may be an “opt-out” system where a user must take action to block ads.

Not every target of an ad is likely to be engaging in a browser search or even looking at their computer screen or mobile device, particularly if they are at a sports event or other event, meaning advertisers must resort to more traditional methods (printed signs, flyers, arena banners and the like) to reach targets who do not own a computer or mobile device, or who do not spend much time looking at their computer or electronic device.

From the advertiser's perspective, problems include paying for “clicks” that do not convert to sales; paying for delivery to users who are not interested in the ad content; and, as a result, high cost of digital ad campaigns that deliver few actual sales and few truly engaged users. Stated another way, though the past pay-per-impression systems aim to achieve a high degree of correspondence between cost of the ad campaign and number of truly engaged users, they fall short.

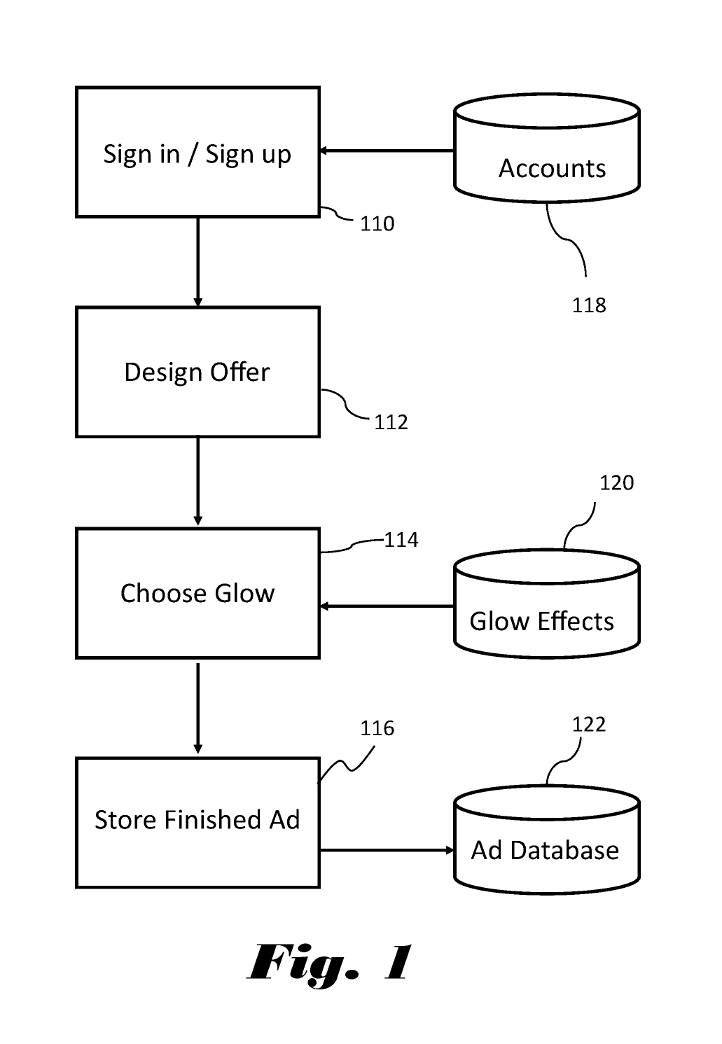

Therefore, there is a need in the art for a digital ad delivery system that delivers ads the users want to see and want to engage with. Advertisers desire a system that delivers ads to receptive users who want to engage with the ads delivered to them. The disclosed system may work across a wide variety of platforms, even beyond the traditional digital space of computer browsers and mobile devices to deliver dynamic, targeted ads to physical devices and spaces not traditionally used for digital advertising. This disclosure relates to an advertising system and method shown in FIGS. 1-4. As used herein ad includes offer; brand refers to an image, words, or color associated with a specific advertiser; advertiser includes third parties working on their behalf, i.e. agencies and marketing professionals.

The system may include a “glow server system”, which may include a digital ad delivery system that delivers ads the users want to see and want to engage with. The system may deliver dynamic, targeted, interactive ads across multiple digital platforms, including multiple social media platforms and multiple browsers, as well as electronic signs and displays, televisions, V/R and A/R viewing devices, even operating systems (computer desktops and device home screens, for example). The system in some embodiments may work across platforms even beyond the traditional digital space of computer browsers and mobile devices to deliver dynamic, targeted ads to physical devices and spaces not traditionally used for digital advertising. Such “non-traditional” spaces may include signs and displays at public places such as shopping malls, stadiums, airports, waiting rooms, train, subway and bus stations; digital billboards; even interior or exterior walls using a projector or other display method, mirrors and windows using display methods currently in use or developed in the future, and other displays using methods and systems for display which are known or are later developed.

Digital platforms for the delivery of advertisements may include user-specific systems where a user logs into a system, and has an account that is tied to the user, such as a smart phone, tablet, desktop computer, or console. Advertisements may be delivered to user-specific systems through designated advertising space on the display. Designated advertising space includes space that is designated for advertising by the system, including software systems to display a portion of an internet browser window with an advertisement.

Digital platforms for the delivery of advertisements may include public or semi-private display systems where the display is for multiple people to view, (either at the same time or serially) and the display is not controlled by the multiple viewers directly. Public display systems may include digital billboards, waiting room television screens, display screens in public places, and projections on walls, mirrors or windows, as well as other displays that are known or later developed. Semi-private display systems may include television screens or other displays in private clubs or restricted access areas of government, nonprofit or commercial organizations.

Private displays may include television screens or other displays in private residences. As used herein, “public display” includes semi-private displays.

Public or private display systems may include advertisements delivered to at least a portion of the display. The display systems may be connected to a server and may display advertisements based on one or more users that are estimated or confirmed to be within proximity of the display of the display system at that moment. In some embodiments a user may have a mobile device that receives location information and transmits location information to a server. The server may then estimate location, and or future location of the user, and deliver an advertisement based on user preferences to a public display that is likely to be viewed by the user. Public display systems may determine the likely location of a user in other ways. In some embodiments a server may determine the likely location of a user based on the purchase of an event item, such as a ticket to an event, a ticket on an airplane, or an appointment that has a specific time a place. In some embodiments a server may determine likely location based on a user's calendar entries, including estimated travel time and routes between scheduled appointments. A public display may have a viewing zone where users are more likely to see the public display. The viewing zone may include locations where the screen can be seen and other areas where the public display cannot be seen, but where users are within a defined area or distance from the public display. In some embodiments a viewing zone may be limited to locations where the public display can be seen and read by a person with normal eye sight.

In some embodiments an advertisement may be delivered to a public display and a user-specific display. Delivery to the public display and user-specific display may be done in parallel or in series. For example a server may direct public displays to deliver an advertisement with an offer based on a user's preference, and at the same time a mobile device may display the same or related advertisement that allows the user to accept the offer. A user may view a public display and then indicate on a mobile device to save the advertisement or offer for later viewing.

In some embodiments a server may store the location of a public advertisement, which may be a digital advertisement or a non-digital public advertisement. The server may store a viewing zone for the public advertisement with a defined area, and may compare the location of a user with the viewing zone to determine when a user is within the viewing zone of the public advertisement. The server may then send the same advertisement in a digital form, or a related advertisement to the user-specific display of a user that is within the viewing zone of the public advertisement.

Gamification may also be used. In some embodiments a user may be shown advertisements on a user-specific display, with instructions to look for the same advertisement or the same brand on a public display. The user may be rewarded with points, discounts, or other incentives if they acknowledge viewing of the advertisement on a public display. The user's acknowledgement of the viewing of the advertisement may include time and location data and may be correlated with public-display location to confirm delivery of the advertisement through the public display. A server may store a proximity zone, which may be a defined geographic area near the proximity zone, which may be the same as or different from the viewing zone. The server may compare a user's location sent with an acknowledgement of the viewing of the advertisement on the public display, and determine if it the user was within the proximity zone when acknowledging the viewing of the advertisement on the public display. In some embodiments a mobile device may store a history of locations where the user has traveled recently, such as a defined time period, and receive the public-display location. The mobile device may send a confirmation to the server that the mobile device was recently within the proximity zone or viewing zone of the public display. In other embodiments a mobile device may send the saved history of recent locations to a server, and the server may confirm that the mobile device was within the proximity zone or the viewing zone.

A server may receive information that more than one user is in a proximity zone, or likely to be in proximity to a public display, and may determine common user preferences to deliver advertisements that appeal to more than one person likely to view the public display. A server may determine which advertisement to display, when choosing between the display of different advertisements based, at least in part, on the number of users that are likely to be in proximity of the public display.

For example, a sporting event may have a public display that is primarily viewed from a first section of the audience. Users may have a preference between two teams playing at the event, and may have designated their preference for one of the two teams, and that preference may be stored in a database accessible by a server. The server may correlate specific users to the first section of the audience based on location information from a mobile device, or from ticket purchase information, or from calendar information or other source that would indicate that the user is likely to be in the first section during the sporting event. A server may determine whether there are more fans for one team or the other team based on user preferences of users who are confirmed or likely to be in the first section. In an example the server may automatically decide to advertise merchandise based on the brand of one team or the other team based on the percentage of fans for each team in the first section (or likely to be in the first section).

Ads may include offers. Ads may be dynamic and interactive via incorporating the glow technology which is described in applicant's prior patent applications from which priority is claimed. Ads incorporating the glow technology may be called “glow ads” herein to differentiate them from static, traditional ads.

Glow ads may convey information through a glow. As used herein, “glow” means a dynamic digital effect capable of capturing a user's attention; “glow” includes visual digital effects, such as glowing, sparkling or other dynamic visual effects, and nonvisual digital effects, such as sounds, vibrations or other sensory effects; A database may include user preference and opt-in database which may enhance targeting accuracy and user interest and may increase chances of engagement; interactive glow ads may indicate that offers may be purchased on the spot—convenient for users and much more valuable for advertisers; or a glow ad may be designed for engagement that captures valuable data from a user, such as a survey or game to identify other user interests, other leads and preferences, even just to prime a user for a future offer. As a result, impressions on the glow ad are more meaningful and more likely to lead to immediate sale.

A glow server system incorporating the glow technology and the “opt-in” model may deliver superior targeting and delivery of ads to users who want to engage with the ads delivered. A glow server system may also include engagement opportunities which provide greater value to advertisers than traditional “pay per click” digital ads. Instead of paying a flat amount (for example $0.10) for a “click”, impressions with a glow ad may be separated into several types of impressions and each impressions assigned a value. For example, each of the following may be an impression valued at an incremental amount (for example $0.015): Delivering a glow ad to a user without an active glow; Delivering an active glow to a glow ad; User looking at user's device in response to an active glow (may be captured using device's accelerometer, the device's camera or other means); User clicking on a glow ad; User clicking within glow ad to view additional ad content; User taking desired terminal action (for example, purchase, survey, playing game, sharing information). Therefore, advertisers only pay the full value for user engagements that deliver the desired terminal action and pay only incrementally for impressions of lesser value.

The glow server system may track a user's engagement with glow ads by capturing user impressions throughout user's interaction with a glow ad, from first impression through last impression. The glow server system may capture and track enhanced user engagement data through capturing facial expressions, voiced expressions, eye-tracking, hand temperature, perspiration, pulse and other biometric sensor data. The glow server system may store this user engagement data in the account database to be used by the advertiser and/or the glow server system to improve glow ad targeting and engagement over time. Alternatively, the glow server system may transmit this user engagement data to an advertiser or third party who wishes to collect data relating to users' engagement with an advertiser's glow ads.

Referring to FIG. 1, an example glow server system may be used by an advertiser. The system may include an advertiser portal. Advertisers may begin using the example glow server system by creating an advertiser account, or logging into a previously created advertiser account through a sign up interface 110. The glow server system may store information regarding the advertiser account in an account database 118.

The advertiser may then design an offer or advertisement through an offer design interface 112. An advertiser may upload an offer or advertisement that was previously created on a different system, or select an advertisement that was previously created for use or modification. An ad designing engine may be used to create the offer or advertisement. An ad design engine may include a glow design module with a library of glow effects. The advertiser may use a glow selection interface 114 to add effect to the advertisement or offer. An effects database 120 may store effects including glow effects to be inserted into the advertisement or offer. In some embodiments an advertiser may create custom effects including custom glows that may include brand images, brand sounds or brand colors or other effects that are desired. In some embodiments an advertiser may create an advertisement or offer that does not include a glow effect.

The advertiser may use an ad storage interface 116 to store a completed advertisement in an ad database 122. The advertisement may be stored in the ad database 122 and sent to a user when it is called by an advertisement server. The ad storage interface 116 may prepare the glow ad to be exported to the advertiser's (or a third-party's) database in which it is stored and delivered to a user when called.

In some embodiments the advertiser portal may include an options/pricing/contract module that is connected communicatively with a the account database 118.

The ad designing engine that is part of the offer design interface 112 may include an ad content module, an offer content module and an ad rules module. An ad rules module may collect advertiser choices with respect to various attributes for the ad. Ad attributes may include target user demographics, target user interests, target user preferences, geographic region/scope, ad spend/budget, platform(s) for delivery, type of ad or offer, terminal impression (desired final action).

The glow design interface 114 may collect advertiser choices with respect to various glow effects selected from a library of pre-built glow effects. The glow design interface 114 may include a glow design module that may collect advertiser choices with respect to various attributes for the glow. Glow attributes may include color, speed, direction, animation, birth rate, or other variables and custom attributes, such as uploading a brand logo or trademark color. The glow design interface 114 may include a glow insertion module that may include an upload link where an advertiser may upload a traditional static ad. The glow design interface may also include an ad design parameter collection component; a glow parameter collection component; and a packaging and export module.

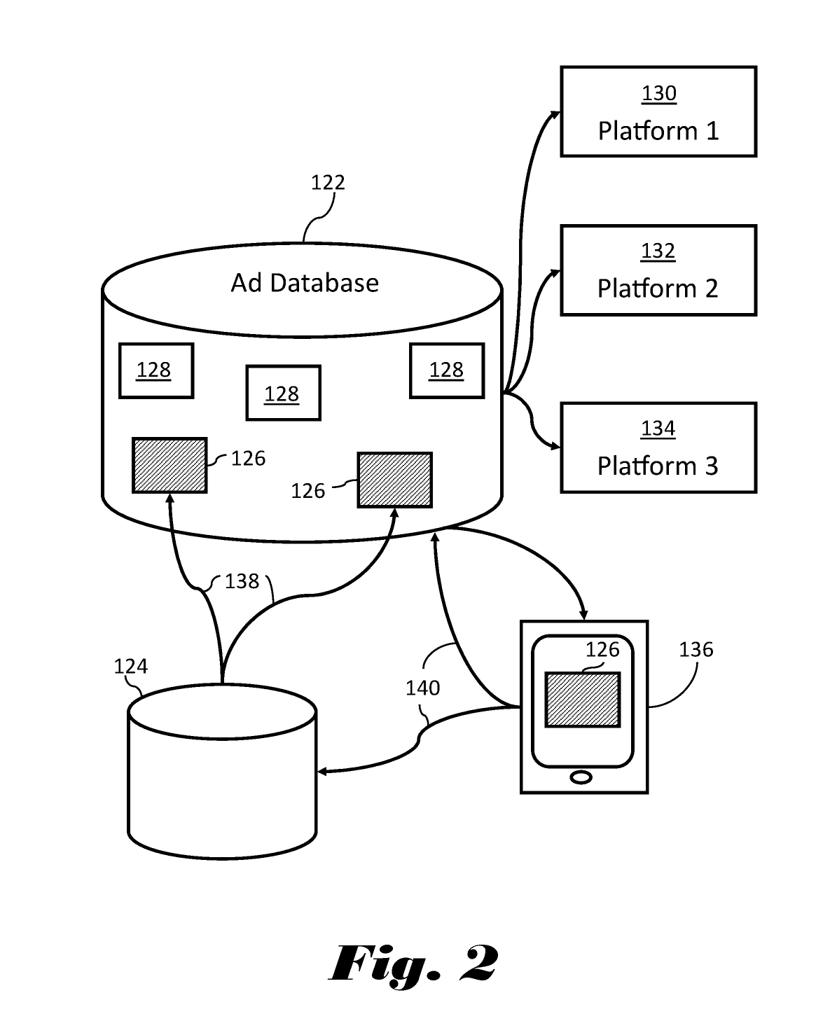

Referring to FIG. 2, an example of an ad database 122 of the system may include a cloud-hosted database indexed by advertiser. An advertiser's ads may be delivered to the ad database when the advertiser completes the glow ad design process. An advertiser's ads may be stored in the ad database and sent to a user when called for delivery. For example an ad may be delivered from the ad database 122 to one of multiple platforms 130, 132, 134, or to a user's mobile device 136.

The ad database 122 may store digital ads 128 in non-volatile memory that do not have a glow effect connected to the ad. The digital ads 128 may be received from the glow server 124 or from a different source. The ad database 122 may store glow ads 126 in non-volatile memory.

The glow server 124 may include an ad packaging and export module which may include a process to attach tags 138 that may enable a glow ad to be exported to an advertiser's or third party's ad database without losing connectivity to the glow server system.

Tags 138 may include a communications tag to enable a glow ad to receive and transmit communications from the glow server system even on a third party's database. Communications tags may include a counting tag to enable counted impressions to be communicated back to the glow server system.

When a glow ad 126 is sent to one of the ad platforms such as the mobile device 136, tags may enable the ad platform to gather user interaction/engagement data 140 and send the user interaction data 140 to the glow server 124 to be stored in non-volatile memory.

Digital ads 128 and glow ads 126 may be delivered to multiple different ad platforms as described in other parts of this document. For example, ad platform one, 130 may be a digital billboard, ad platform two, 132 may be an advertisement in a side bar on a social media site, ad platform three, 134 may be a television in a restaurant that delivers ads, and mobile device 136 may be a cell phone, tablet, wearable device with a display, or other mobile device.

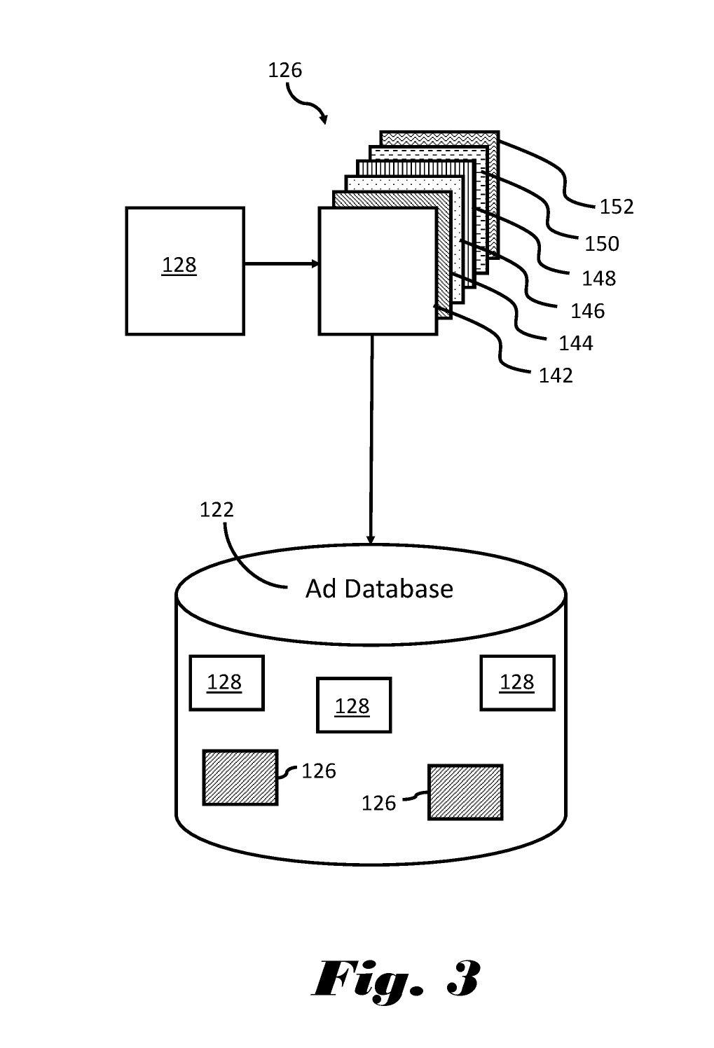

Referring to FIG. 3, in some embodiments a digital ad 128 may be used to create a glow ad 126. In some embodiment a glow ad may include ad content 142 to be displayed (may be multiple layers—i.e. initial, display if clicked, video, offer); and various tags, which may be piggybacked computer code to enable the glow ad functionality. Glow ad tags may include an ad delivery tag, 144, with rules for delivery of the ad; a glow rules tag 146 for the glow (when to glow and how to glow); an interactivity tag 148 (which may include content of the offer and what happens when user clicks in specific locations); an impression counter 150 (to collect impressions, track and store impression data, and communicate impressions data back to glow server system and, which may send data to advertiser for billing and user engagement information); and a communication tag 152 to enable communications to and from the glow server system. In some embodiments a glow ad 126 may have more or less tags than in this example.

In some embodiments glow ads 126 may be stored on an ad database 122. A glow ad 126 may be delivered as a traditional digital ad without the glow technology, or it may be delivered with the glow technology.

Because the glow technology may be inserted into the individual ads, it may travel with each ad wherever the ad is delivered. The glow technology may be portable in that it may be used without relying on any special code in a user's device to deliver a glow ad but rather the glow ad may carry with it all the code needed to deliver the glow and other functionality to a wide variety of devices over a wide variety of platforms and communicate with the glow server system as needed.

In embodiments where a glow ad is delivered outside traditional media for targeted digital advertising (traditional digital advertising may include mobile devices, websites, social media), a glow might signal to a user that an engagement opportunity is available should the user be interested. If the user is interested at that time, the user may choose to engage by looking at the user's mobile device to view the glow ad. Or, a user may choose not to engage.

A glow server system may provide advertisements with a lower annoyance factor: dynamic glow ads let the user know an offer or ad or more information is available without forcing the user to see the additional information. A user may simply ignore the glow and continue using the device or enjoying an event without interruption.

A glow server system may provide content with higher relevance to the user through better targeting: because the user has defined their preferences, the system may target ads using an “opt-in” system rather than an “opt-out” system. A glow server system may provide enhanced accuracy in targeting by capturing a user's biometric information, such a fingerprint, face or other identifying characteristics, and matching it to a user's stored biometric information as verification.

A glow server system may provide better engagement by users: because the ads may be better targeted and also dynamic and interactive, the user may be more apt to engage with the ad. Moreover, as noted above, the system provides that an ad may be an offer, and more particularly, a geo-targeted and/or time limited offer. A user is more likely to purchase an offer “on the spot”, i.e. immediately upon seeing the offer, if the offer is geo-targeted or time limited. Because the system may enable not just dynamic but also interactive ads, an ad may be designed as an offer with a point-of-purchase opportunity (such as “click to buy”). A glow server system may provide enhanced security in connection with a point-of-purchase opportunity by capturing a user's biometric information at the point of purchase, such a fingerprint, and matching it to the user's stored biometric information as verification that the purchaser is indeed a user with authority to draw funds from the payment account. Another type of interactive ad delivered by the system may be a “gamified” ad where the user may play a game or a test of knowledge or skills in order to unlock a prize or offer. Increased meaningful engagement with ads means a much higher chance of converting the user into a sale either at the moment of engagement or soon thereafter.

A glow server system may provide positive brand reaction: Whereas the prior systems may create negative brand feelings (annoyance, frustration) when a user is confronted with an ad for a brand's product, applicant's system fosters positive brand feelings, e.g. brand loyalty, as a user chooses his favorite brands and communicates his interest in receiving offers from them. Users increasingly appreciate having a choice of which ads to see and when to see them. The use of glow technology to communicate the existence of an ad and information about that ad is another way applicant's system allows users to choose whether and when they wish to view certain ads. Because the communication is accomplished by alerting without interruption of the user's activities and without undue distraction, users find them respectful and helpful rather than frustrating and annoying.

The glow server system may provide brands with more options in designing ads: advertisers may design and build their ad using their choice of tools from a toolbox including a choice of “glow” effects and even custom elements.

The glow technology, including the dynamic interactive icons described in applicant's prior patent applications (from which priority is claimed) may be used to deliver dynamic, interactive ads across digital platforms (including social media platforms, browsers and other digital platforms) and even outside the traditional digital platforms.

In some embodiments an ad exchange Demand Side Platform (DSP) model may be used to determine which ads to deliver to a user, and the fee to the advertiser for delivering the ad. In some embodiments a glow ad may be part of an ad exchange model, where advertisers bid to have glow ads delivered, and the advertiser with the highest bid will have its glow ad be delivered.

In some embodiments a subscription model may be used to determine the cost of ads. Advertisers may select from several subscription choices at various price points. In a basic subscription, glow effects may be selected from a library of pre-built glow effects. In a premium subscription, advertisers may build custom glows incorporating their trademarks and brands.

In some embodiments the glow technology may be portable and may travel with the digital ad as it is served to different platforms. More specifically, the tag in the glow ad may piggyback on the traditional code which directs the browser, app or other destination to display the digital ad; and the tags may include a data capture module which includes an impression counter and the code necessary to send the captured data (including number and type of impressions and enhanced engagement data) back to the glow ad server where it is processed (for invoicing the advertiser and delivering orders or purchases from the viewer) and stored for future use (which includes tracking whether user opted out of that brand; how the user interacted with the ad; whether the user purchased; user captured data re location and/or other data desired by the advertiser).

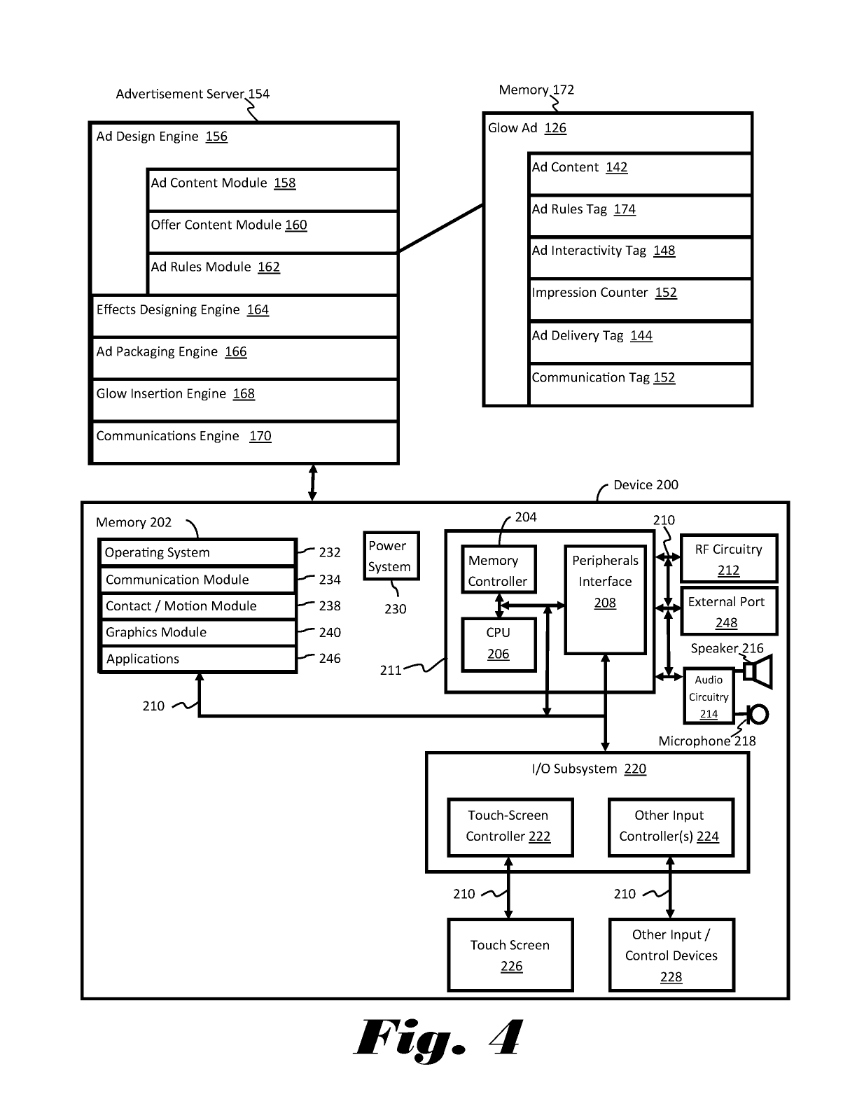

FIG. 4 illustrates an advertisement server 154 connected to memory 172, and which may be communicatively connected to an electronic device 200, according to some embodiments.

In some embodiments the advertisement server 154 may include an ad design engine 156, an effects designing engine 164, an ad packaging engine 166, a glow insertion engine 168 and/or a communications engine 170. The ad design engine 156 may include an ad content module 158, an offer content module 160 and/or an ad rules module 162. The ad design engine 156 may include a glow design module with a library of glow effects.

The ad content module 158 may include the offer design interface 112 (from FIG. 1) and may allow an advertiser to include the ad content 142 to be used in the glow ad 126. The ad content module 158 may allow an advertiser to insert words, images, designs, patterns, sounds, video and colors into an ad that can be viewed by users.

The offer content module 160 may allow an advertiser to enter and adjust the terms of an offer that is related to an ad. Terms of the offer may include the expiration date of a coupon or sale, the amount of a discount, geographic scope of the offer, and other items relating to an offer in an ad.

The ad rules module 162 may create the ad rules tag 174 for use with the glow ad 126. The ad rules tag 174 may include code created which tells the server system when, where and to whom to serve the ad with the glow and without the glow and what to do with the data coming back from the viewer re engagement, impressions, purchases, and opt-in activity. The ad rules module 162 may insert code as an ad rules tag 174 into a created ad which tells the server system when, where and to whom to serve the ad with the glow and without the glow and what to do with the data coming back from the viewer re engagement, impressions, purchases, opt-in activity. The ad rules module 162 may collect advertiser choices with respect to various attributes for the ad. Ad attributes may include target user demographics, target user interests, target user preferences, geographic region/scope, ad spend/budget, platform(s) for delivery, type of ad or offer, terminal impression (desired final action).

The effects design engine 164 may include a glow selection interface 114 (shown in FIG. 1) and may allow an advertiser to design or select effects such as glow effects as described herein, and as described in applicant's prior filed applications.

The ad packaging engine 166 may assemble ad content 142 and prepare the ad to be delivered on various platforms. The ad packaging engine 166 may convert the ad into the proper format for delivery. The ad packaging engine 166 may prepare the glow ad 126 to be exported and then export the glow ad 126 to its intended destination, which may include, a glow server, the advertiser's database, an ad exchange, or the targeted user. The ad packaging engine 166 may prepare parts of the glow ad to work together and to work with the glow server.

The glow insertion engine 168 may add glow technology and attributes to a pre-existing digital ad. The glow insertion engine 168 may include a glow design module with a library of glow effects.

The communications engine 170 may insert a communications tag 152 in to a glow ad 126. The communications engine 170 may receive information related to delivery and interaction with the ad, and enable communication from the glow ad 126.

The device 200 may include a memory 202, a memory controller 204, one or more processing units (CPU's) 206, a peripherals interface 208, RF circuitry 212, audio circuitry 214, a speaker 216, a microphone 218, an input/output (I/O) subsystem 220, a touch screen 226, other input or control devices 228, and an external port 248. These components may communicate over the one or more communication buses or signal lines 210. The device 200 can be any portable electronic device, including but not limited to a handheld computer, a tablet computer, laptop computer, a mobile phone, a digital watch or other “wearables”, a media player, a personal digital assistant (PDA), or the like, including a combination of two or more of these items, and one or more of these items may be a hand-held electronic communication device. It should be appreciated that the device 200 is only one example of a hand held electronic communication device 200, and that the device 200 may have more or fewer components than shown, or a different configuration of components. The various components shown in FIG. 4 may be implemented in hardware, software or a combination of both hardware and software, including one or more signal processing or application specific integrated circuits.

The memory 202 may include high speed random access memory and may also include non-volatile memory, such as one or more magnetic disk storage devices, flash memory devices, or other non-volatile solid state memory devices. In some embodiments, the memory 202 may further include storage remotely located from the one or more processors 206, for instance network attached storage accessed via the RF circuitry 212 or external port 248 and a communications network (not shown) such as the Internet, intranet(s), Local Area Networks (LANs), Wide Local Area Networks (WLANs), Storage Area Networks (SANs) and the like, or any suitable combination thereof. Access to the memory 202 by other components of the device 200, such as the CPU 206 and the peripherals interface 208, may be controlled by the memory controller 204.

The peripherals interface 208 couples the input and output peripherals of the device to the CPU 206 and the memory 202. The one or more processors 206 run various software programs or sets of instructions stored in the memory 202 to perform various functions for the device 200 and to process data.

In some embodiments, the peripherals interface 208, the CPU 206, and the memory controller 204 may be implemented on a single chip, such as a chip 211. In some other embodiments, they may be implemented on separate chips.

The RF (radio frequency) circuitry 212 receives and sends electromagnetic waves. The RF circuitry 212 converts electrical signals to and from electromagnetic waves and communicates with communications networks and other communications devices via the electromagnetic waves. The RF circuitry 212 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 212 may communicate with the networks, such as the Internet, also referred to as the World Wide Web (WWW), an Intranet or a wireless network, such as a cellular telephone network, a wireless local area network (LAN) or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g or IEEE 802.11n, or IEEE 802.11ac), voice over Internet Protocol (VoIP), Wi-MAX, a protocol for email, instant messaging, or Short Message Service (SMS)), or any other suitable communication protocol, including communication protocols not yet developed as of the filing date of this document.

The audio circuitry 214, the speaker 216, and the microphone 218 provide an audio interface between a user and the device 200. The audio circuitry 214 receives audio data from the peripherals interface 208, converts the audio data to an electrical signal, and transmits the electrical signal to the speaker 216. The speaker 216 converts the electrical signal to human-audible sound waves. The audio circuitry 214 also receives electrical signals converted by the microphone 218 from sound waves. The audio circuitry 214 converts the electrical signal to audio data and transmits the audio data to the peripherals interface 208 for processing. Audio data may be retrieved from or transmitted to the memory 202 or the RF circuitry 212 by the peripherals interface 208. In some embodiments, the audio circuitry 214 also includes a headset jack (not shown). The headset jack provides an interface between the audio circuitry 214 and removable audio input/output peripherals, such as output-only headphones or a headset with both output (headphone for one or both ears) and input (microphone).

The I/O subsystem 220 provides the interface between input/output peripherals on the device 200, such as the touch screen 226 and other input/control devices 128, and the peripherals interface 108. The I/O subsystem 120 includes a touch-screen controller 122 and one or more input controllers 124 for other input or control devices. The one or more input controllers 124 receive/send electrical signals from/to other input or control devices 128. The other input/control devices 128 may include physical buttons (e.g., push buttons, rocker buttons, etc.), dials, slider switches, sticks, and so forth.

The touch screen 226 provides both an output interface and an input interface between the device and a user. The touch-screen controller 222 receives/sends electrical signals from/to the touch screen 226. The touch screen 226 displays visual output to the user. The visual output may include text, graphics, video, and any combination thereof. Some or all of the visual output may correspond to user-interface objects, for example soft keys or soft buttons for user input.

The touch screen 226 also accepts input from the user based on haptic or tactile contact. The touch screen 226 forms a touch-sensitive surface that accepts user input. The touch screen 226 and the touch-screen controller 222 (along with any associated modules or sets of instructions in the memory 202) detects contact (and any movement or break of the contact) on the touch screen 226 and converts the detected contact into interaction with user-interface objects, such as one or more soft keys, that are displayed on the touch screen. In an exemplary embodiment, a point of contact between the touch screen 226 and the user corresponds to one or more digits of the user. The touch screen 226 may use LCD (liquid crystal display) technology, or LPD (light emitting polymer display) technology, although other display technologies may be used in other embodiments. The touch screen 226 and touch-screen controller 222 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 226. The user may make contact with the touch screen 226 using any suitable object or appendage, such as a stylus, finger, and so forth.

In some embodiments, in addition to the touch screen 226, the device 200 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 226 or an extension of the touch-sensitive surface formed by the touch screen 226.

The device 200 also includes a power system 230 for powering the various components. The power system 230 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system 232, a communication module (or set of instructions) 234, a contact/motion module (or set of instructions) 238, a graphics module (or set of instructions) 240, and one or more applications (or set of instructions 246.

The operating system 232 (e.g., Darwin, RTXC, LINUX, UNIX, OS X, WINDOWS, or an embedded operating system such as VxWorks) includes various software components or drivers for controlling and managing general system tasks (e.g., memory management, storage device control, power management, etc.) and facilitates communication between various hardware and software components.

The communication module 234 facilitates communication with other devices over one or more external ports 248 and also includes various software components for handling data received by the RF circuitry 212 or the external port 248. The external port 248 (e.g., Universal Serial Bus (USB), FIREWIRE, etc.) is adapted for coupling directly to other devices or indirectly over a network (e.g., the Internet, wireless LAN, etc.).

The contact/motion module 238 detects contact with the touch screen 226, in conjunction with the touch-screen controller 222. The contact/motion module 238 includes various software components for performing various operations related to detection of contact with the touch screen 226, such as determining if contact has occurred, determining if there is movement of the contact and tracking the movement across the touch screen, and determining if the contact has been broken (i.e., if the contact has ceased). Determining movement of the point of contact may include determining speed (magnitude), velocity (magnitude and direction), or an acceleration (including magnitude or direction) of the point of contact. In some embodiments, the contact/motion module 138 and the touch-screen controller 122 also detect contact on the touchpad.

The graphics module 240 includes various known software components for rendering and displaying graphics on the touch screen 226. Note that the term “graphics” includes any object that can be displayed to a user, including without limitation text, web pages, icons (such as user-interface objects including soft keys), digital images, videos, animations and the like.

The one or more applications 246 can include any applications installed on the device 200, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc.

The advertisement server 154 may deliver ads to other devices which are not mobile device, and which may have more or less modules, systems, and functions than device 200.

Tracking tags may be digital tags corresponding to a user's face, body, physical or digital characteristics. Tracking tags may originate from the user's person, wearables or other devices carried or worn by the user (active identification). Alternatively, tracking tags may originate from a passive identification device at a location, such as a camera or a biometric sensor or capture device, such as a voice analyzer, face scanner, fingerprint reader or biometric scanner.

In the foregoing description, embodiments are described as a plurality of individual parts, and this is solely for the sake of illustration. Accordingly, it is contemplated that some additional parts may be added, some parts may be changed or omitted, and the order of the parts may be re-arranged, without leaving the sense and understanding of the apparatus as claimed.

What is claimed is:

1. A method of enhancing an advertisement database comprising the steps of:
Receiving ad content by an advertisement server and storing the ad content in non-volatile memory that is communicatively connected to the advertisement server;
Receiving, by the advertisement server, ad rules related to the ad content and storing the ad rules in the non-volatile memory with a correlation to the ad content;
Receiving, by the advertisement server, a selection of a digital effect that is associated with the ad content, and storing the digital effect in the non-volatile memory;
Assembling, by the advertisement server, the ad content, the ad rules and the digital effect to create a glow ad; and
Sending, by the advertisement server, the glow ad to the advertisement database.

2. The method of claim 1, wherein the advertisement server includes an ad designing engine, wherein the step of receiving the ad rules is performed by the ad designing engine, and wherein the step of receiving the ad content is performed by the ad designing engine, and wherein the method includes Receiving, by the ad designing engine, offer content.

3. The method of claim 1 wherein the advertisement server includes an ad designing engine, and wherein the ad designing engine includes an ad content module, an offer content module, and an ad rules module; wherein the method includes Receiving, by the ad rules module, an ad attribute.

4. The method of claim 3 wherein the ad attribute includes target user demographics, target user interests, target user preferences, and geographic user scope, ad budget, delivery platforms, type of ad, and terminal impression.

5. The method of claim 1 wherein the advertisement server includes an effects designing engine, and wherein the method includes displaying, by the effects designing engine, multiple digital effect choices, and receiving, by the effects designing engine, the selection of the digital effect.

6. The method of claim 1 wherein the advertisement server includes an ad packaging engine, wherein the method includes attaching, by the ad packaging engine, a communication tag to the glow ad to allow the glow ad to communicate with a glow server.

7. The method of claim 1 further comprising attaching, by the advertisement server, an ad delivery tag to the ad content, and wherein the step of sending the glow ad includes sending the ad delivery tag.

8. The method of claim 1 further comprising attaching, by the advertisement server, a glow rules tag to the ad content, and wherein the step of sending the glow ad includes sending the glow rules tag.

9. The method of claim 1 further comprising attaching, by the advertisement server, an interactivity tag to the ad content, and wherein the step of sending the glow ad includes sending the interactivity tag.

10. The method of claim 1 further comprising attaching, by the advertisement server, an impression counter to the ad content, and wherein the step of sending the glow ad includes sending the impression counter.

11. The method of claim 1 wherein the glow ad includes a communication tag to the ad content, and wherein the step of sending the glow ad includes sending the communication tag.

12. The method of claim 1 further comprising:
Receiving, by the advertisement server, a user location;
Comparing the user location to a public-display location of a fixed public display to determine a proximity value; and
Sending a first glow ad to the fixed public display based on the proximity value.

13. The method of claim 12 further comprising:
Sending a second glow ad that is related to the to the first glow ad to a user-specific display that is within a defined area for viewing the public display at substantially the same time as the first glow ad is sent to the fixed public display.

14. The method of claim 1 further comprising:
Receiving, by the advertisement server, multiple user locations;
Comparing the multiple user locations to a public-display location of a fixed public display to determine a proximity value; and
Sending the glow ad to the fixed public display based on the proximity value.

15. The method of claim 1 further comprising:
Receiving, by the advertisement server, interaction data that is related to interaction with the digital effect.

16. An advertisement server comprising:
An ad designing engine that receives ad content and stores the ad content in non-volatile memory;
An ad rules module that receives ad rules related to the ad content and stores the ad rules in the non-volatile memory with a correlation to the ad content;
An effects designing engine that displays multiple digital effect choices for the ad content, and receives a selection of a digital effect;
An ad packaging engine that attaches a communication tag to the ad content; and
Assembling, by the advertisement server, the ad content, the ad rules, the digital effect and the communication tag to create a glow ad.

17. The advertisement server according to claim 16 further comprising storing the glow ad with an ad delivery tag in the non-volatile memory.

18. The advertisement server according to claim 16 further comprising storing the glow ad with a glow rules tag in the non-volatile memory.

19. The advertisement server according to claim 16 further comprising storing the glow ad with an interactivity tag in the non-volatile memory.

20. The advertisement server according to claim 16 further comprising storing the glow ad with an impression counter in the non-volatile memory.

21. The advertisement server according to claim 16 further comprising storing the glow ad with an impression counter in the non-volatile memory.
